(19) United States
(12) Patent Application Publication
(10) Pub. No.: US 2014/0144024 A1
(43) Pub. Date: May 29, 2014

(54) Method Of Welding Work Pieces Together

(71) Applicant: James R. Byrne, II, Shelby Township, MI (US)

(72) Inventor: James R. Byrne, II, Shelby Township, MI (US)

(21) Appl. No.: 14/232,423

(22) PCT Filed: Jul. 19, 2012
(86) PCT No.: PCT/CA2012/000692

§ 371 Date: Jan. 13, 2014

Related U.S. Application Data
(60) Provisional application No. 61/509,207, filed on Jul. 19, 2011.

(51) Int. Cl. B23K 28/02; B23K 20/12; B60G 3/04; B23K 26/22; B21D 53/88

(52) U.S. Cl. CPC B23K 28/02; B23K 26/22; B21D 53/88; B60G 3/04; B23K 20/122
USPC 29/897.2; 219/121.64; 219/121.46; 228/112.1

(57) ABSTRACT

A method of welding two sheet-like work pieces, such as a web and a belt of a vehicle suspension control arm, is provided. The method includes the step of positioning one of the sheet-like work pieces against and at an angle relative to the other work piece such that the first and second work pieces are in contact with one another by a generally flat contact surface. The method continues with the step of melting with a single welding process material of the first and second work pieces across the entire width of the contact surface.

CROSS-REFERENCE TO PRIOR APPLICATIONS

This U.S. National Stage Patent Application claims priority to International Patent Application No. PCT/CA2012/000692 filed Jul. 19, 2012, entitled “Method Of Welding Work Pieces Together” which claims the benefit of U.S. Provisional Patent Application Ser. No. 61/509,207 filed Jul. 19, 2011, entitled “Welding Assembly And Method,” the entire disclosures of the applications being considered part of the disclosure of this application and hereby incorporated by reference.

### BACKGROUND OF THE INVENTION

1. Field of the Invention

The subject invention is related to welding. More particularly, the subject invention is related to a method of welding two or more work pieces together.

2. Description of the Prior Art

Welding is commonly used in a variety of industries to join two or more work pieces together. A few common types of welding are laser beam welding, metal-inert gas welding, hybrid laser arc welding, friction stir welding, etc. When welding a pair of work pieces together in a T-configuration, i.e. with one of the work pieces oriented perpendicularly to the other, a separate and distinct weld seam is generally created at each of the corners at the intersection of the two work pieces. In the prior art welding methods, one welding assembly can be used to separately melt material of the work pieces at each corner to produce the distinct weld seams, or two separate welding assemblies (one aimed at each corner) could simultaneously melt material of the first and second work pieces to produce the distinct weld seams.

In the automotive industry, welds are present in many vehicle parts. For example, the manufacturing of a control arm for a suspension system often involves at least one welding process to join a web with one or more belt which extends along a portion of the perimeter of the web. Regardless of the type of welding assembly employed, many of the known welding methods generally include at least two separate and distinct weld seams, i.e. one on each corner at the intersection of the web and belt. Additional welds may also be required to connect the web with other components, e.g. a mount or a bushing receiver.

The remains a significant and continuing need for an improved welding method which is cost effective and able to produce a weld with a greater resistance to failure.

### SUMMARY OF THE INVENTION

According to one aspect of the invention, a method of welding a sheet-like first work piece to a sheet-like second work piece is provided. The method includes the step of positioning the first work piece against and at an angle relative to the second work piece such that the first and second work pieces are in contact with one another by a generally flat contact surface. The method proceeds with the step of melting with a single welding process material of the first and second work pieces across the entire width of the contact surface. The melting step may be further defined as melting material from the first and second work pieces across the entire width of the contact surface using a welding assembly aimed at the side of the second work piece opposite of the first work piece. Alternately, the melting step may be further defined as melting material from the first and second work pieces across the entire width of the contact surface using a welding assembly aimed at a corner at the intersection of the first and second work pieces.

According to another aspect of the invention, a method of making a control arm for a vehicle suspension is provided. The method includes the step of positioning a sheet-like belt against and at an angle relative to a sheet-like web such that the belt and web are in contact with one another by a generally flat contact surface. The method proceeds with the step of melting with a single welding process material of the belt and the web across the entire width of the contact surface.

The above described methods are very versatile and could be employed to weld work pieces of a wide range of materials and shapes. Additionally, a range of different types of welding assemblies could be used including, for example, a laser beam welding assembly, a hybrid laser arc welding assembly or a friction stir welding assembly. The resulting weld between the first and second work pieces is at least as resistant to failure as welds produced from other known welding processes, but it may be produced more efficiently and with more reliability than the welds produced by other known welding processes. Additionally, the subject invention is beneficial because it is flexible over a wide range of applications and allows for high blank efficiency when forming the work pieces. Even further, the resulting weld can extend through curves or other features in the first and second work pieces.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1a is a cross-section of a first work piece and a second work piece arranged in a T-configuration with a welding assembly aimed at a surface of the second work piece opposite of the first work piece;

FIG. 1b is a cross-sectional view of the first and second work pieces of Figure la after welding;

FIG. 2a is a cross-section of a first work piece and a second work piece angled relative to one another with a welding assembly aimed at a surface of the second work piece opposite of the first work piece;

FIG. 2b is a cross-sectional view of the first and second work pieces of FIG. 2a after welding;

FIG. 3a is a cross-section of a first work piece and a second work piece arranged in a T-configuration with a welding assembly aimed at a corner of the contact surface between the first and second work pieces;

FIG. 3b is a cross-sectional view of the first and second work pieces of FIG. 3a after welding;

FIG. 4a is a cross-section of a first work piece and a second work piece angled relative to one another with a welding assembly aimed at a corner of the contact surface between the first and second work pieces;

FIG. 4b is a cross-sectional view of the first and second work pieces of FIG. 4a after welding; and

FIG. 5 is a top elevation view of an exemplary control arm formed through a welding process.

### DETAILED DESCRIPTION OF THE ENABLING EMBODIMENTS

One aspect of the present invention is related to a process for welding a pair of work pieces to produce a strong and low-cost weld seam. The work pieces are preferably sheet-like (i.e., thin and generally flat) and could be of a wide range of materials including, for example, steel, aluminum, ferrous materials or non-ferrous materials. Additionally, the work pieces could be formed of the same or different materials.

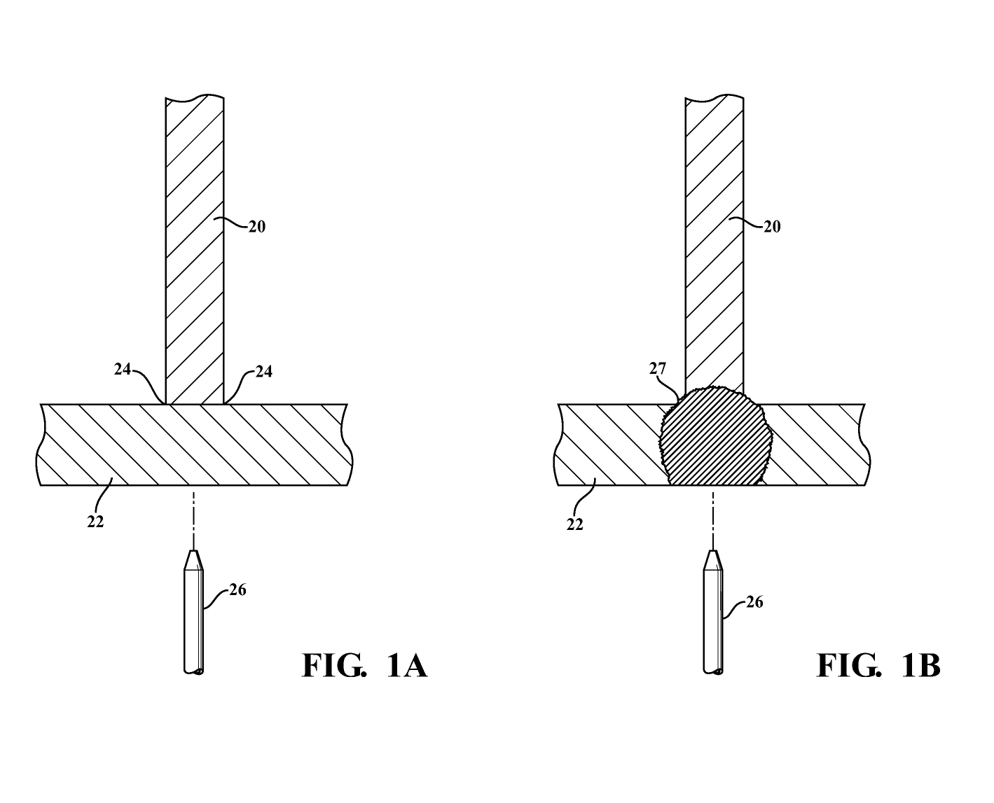

Referring now to FIG. 1a, the first and second work pieces 20, 22 are positioned in a T-configuration with the second first work piece 20 extending perpendicularly away from the second work piece 22. This presents a generally flat contact surface between the work pieces 20, 22 with a corner 24 being exposed on either side of the contact surface. A welding assembly 26 is aimed at the surface of the second work piece 22 opposite of the first work piece 20. When activated, the welding assembly 26 melts material of both of the work pieces 20, 22 including the entire contact surface between the corners 24 of the joint. Referring now to FIG. 1b, after the welding process is complete, a very strong weld seam 27 is formed that extends across the intersection of the work pieces 20, 22. As shown, the weld seam 27 encompasses at least some of the material at each of the corners 24.

The welding assembly 26 is preferably a laser beam welding (LBW) assembly, a hybrid-laser arc welding (HLAW) assembly or a friction stir welding assembly. If the welding assembly 26 is an LBW or HLAW assembly, the diameter, focal point, and power of the laser beam are selected to optimize the amount of material melted between the corners 24 of the contact surface between the first and second work pieces 20, 22. If the welding assembly 26 is a friction stir welding assembly, then the length, diameter and rotational velocity of its spinning probe are selected to optimize the melting of material between the corners 24 of the contact surface between the first and second work pieces 20, 22. It should be appreciated that any other type of welding assembly could alternatively be used.

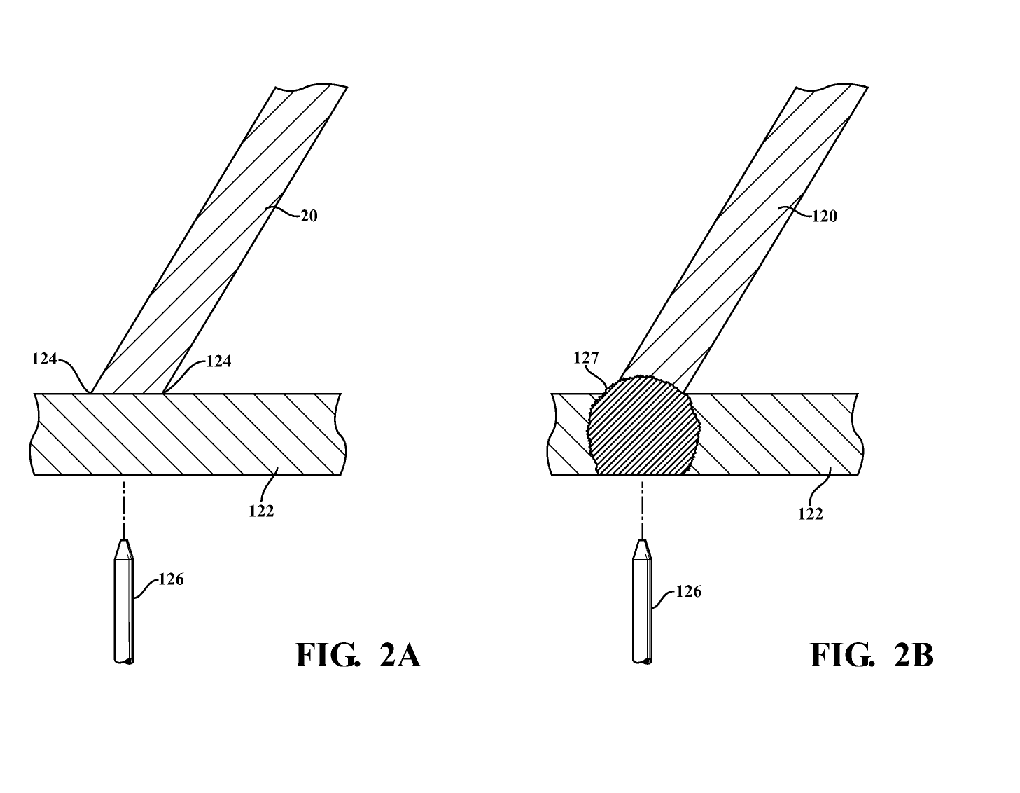

Referring now to FIG. 2a, the first work piece 120 is positioned at an angle relative to the second work piece 122, but the end of the first work piece 320 is angled such that the contact surface between the first and second work pieces 120, 122 is generally flat. As such, corners 124 are exposed on either side of the contact surface. A welding assembly 126 is aimed at the surface of the second work piece 122 opposite of the first work piece 120. When activated, the welding assembly 126 melts material of both of the work pieces 120, 122 including the entire contact surface between the corners 124 of the joint. As shown in FIG. 2b, after the welding process is complete, a very strong weld seam 127 is formed that extends across width of the intersection of the work pieces 120, 122, and the weld seam 127 encompasses at least some of the material at each of the corners 124. It should be appreciated that the work pieces could be positioned at any desirable angle relative to one another so long as the contact surface at the intersection of the work pieces is generally flat.

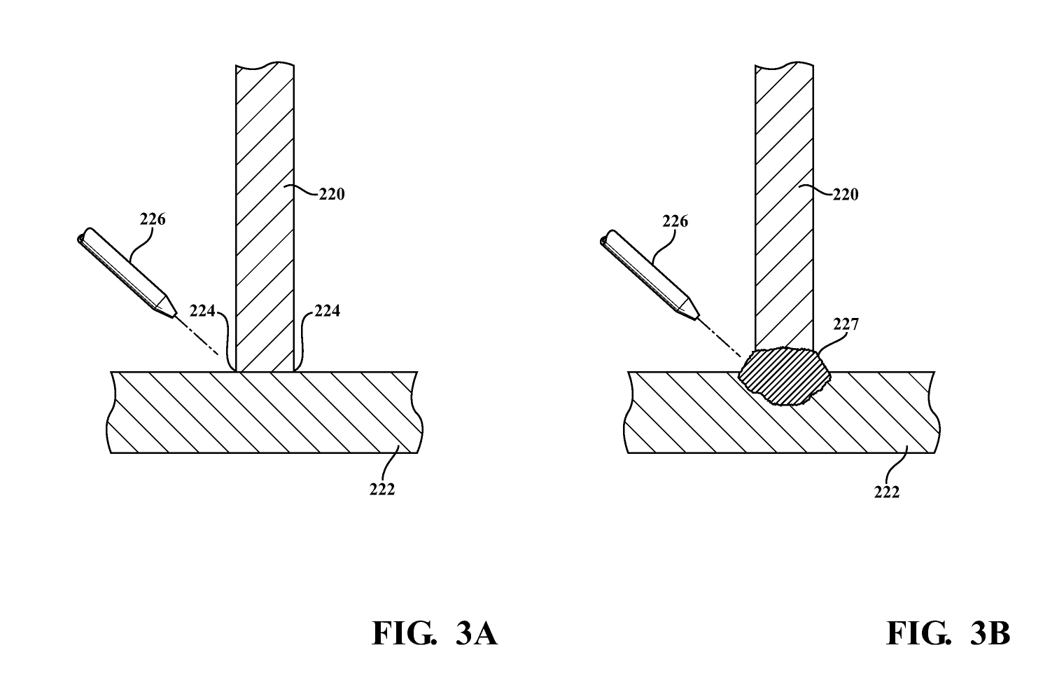

Referring now to FIG. 3a, the first and second work pieces 220, 222 are again shown in the T-configuration discussed above with the contact surface between the work pieces 220, 222 extending between a pair of exposed corners 224. However, FIG. 3a is distinguished from Figure la because the welding assembly 226 is positioned and aimed at one of the corners 224 at a shallow angle relative to the second work piece 322. When the welding assembly 226 is activated, it melts material of the first and second work pieces 220, 222 and penetrates through the work pieces 220, 222 to the opposite corner 224. As shown in FIG. 3b, the resulting weld seam 227 extends across the contact surface between the first and second work pieces 220, 222. The welding assembly 226 is preferably an LBW or an HLAW welding assembly because of their ability to deeply penetrate material and melt the first and second work pieces 220, 222 at the opposite corner 224. Additionally, an LBW and HLAW welding assembly might be preferred to minimize the heat affected zone around the weld seam. However, it should be appreciated that any suitable type of welding assembly could alternately be used.

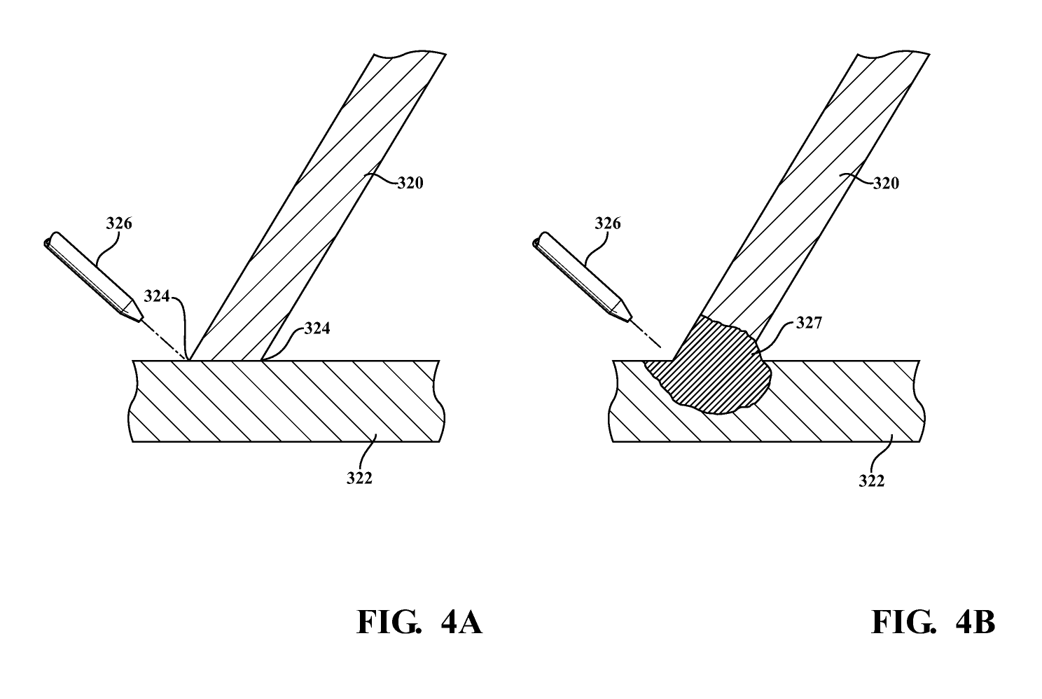

Referring now to FIG. 4a, the first work piece 320 is positioned at an angle relative to the second work piece 322, but the end of the first work piece 320 is angled such that the contact surface between the first and second work pieces 320, 322 is generally flat. Similar to FIG. 3a, the welding assembly 326 is angled at a shallow angle relative to the second work piece 322. When activated, the welding assembly 326 melts material of the first and second work pieces 320, 322 and penetrates through the work pieces 320, 322 to the opposite corner 324.

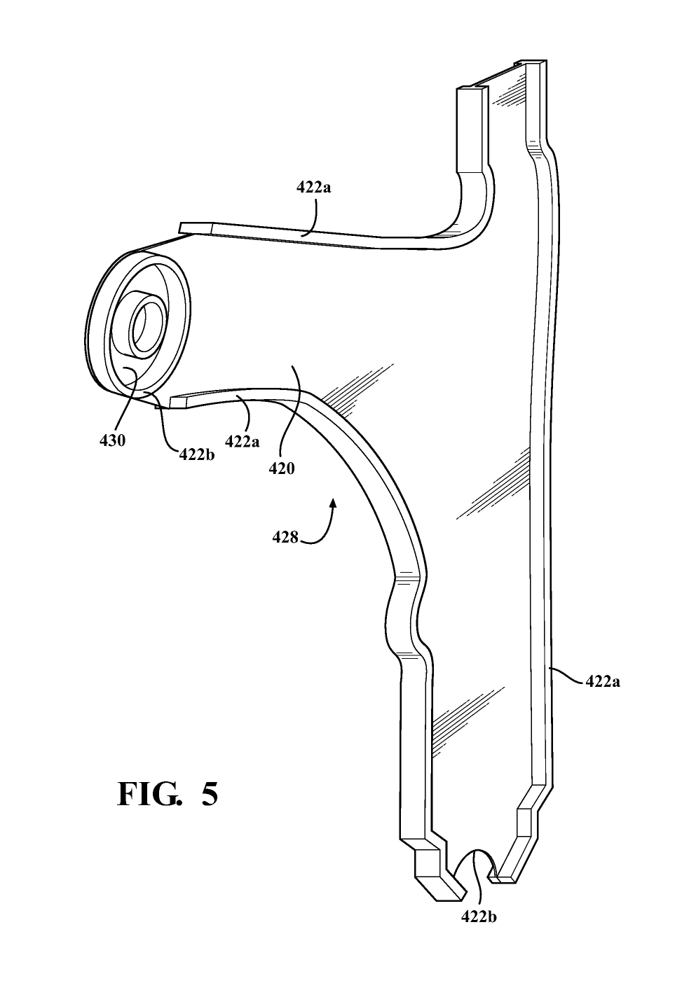

The first and second work pieces could be any desirable metal components and could be separately formed through any desirable process including, for example, stamping, casting, forging, machining, etc. For example, a control arm 428 for a vehicle suspension is generally shown in FIG. 5 which could be formed through either of the above-described welding processes. In the exemplary control arm 428, the web 420 corresponds to the first work pieces discussed above, and the belt 422a, bushing receiver 422b and mount 422c correspond all to the second work pieces discussed above. As shown, the belt 422a extends along a portion of the perimeter of the web 420 for strengthening the control arm 428. The bushing receivers 422b support a plurality of bushings 430 for connection to a wheel assembly (not shown) or a frame (not shown) of a vehicle (not shown). As can be seen, either of the above-discussed welding processes can weld around curves of the belt 422a and bushing receivers 422b.

Either of the above-described welding processes is modular can be used to form a variety of parts very quickly and cost effectively. Additionally, a variety of different types of welding assemblies can be used, and the work pieces joined together can be of a range of different materials.

According to another aspect of the invention, a method of welding a sheet-like first work piece 20 to a sheet-like second work piece 22 is provided. The method includes the step of positioning the first work piece 20 against and at an angle relative to the second work piece 22 such that the first and second work pieces 20, 22 are in contact with one another by a generally flat contact surface. The method proceeds with the step of melting with a single welding process material of the first and second work pieces 20, 22 across the entire width of the contact surface.

The melting step may be further defined as melting material of the first and second work pieces 20, 22 across the entire width of the contact surface with a single welding process using a welding assembly 26 aimed at the side of the second work piece 22 opposite of the first work piece 20. Alternately, the melting step may be further defined as melting material from the first and second work pieces 20, 22 across the entire width of the contact surface between the first and second work pieces 20, 22 using a welding assembly 26 aimed at a corner 24 at the intersection of the first and second work pieces 20, 22.

According to yet another aspect of the invention, a method of making a control arm 428 for a vehicle suspension is provided. The method includes the step of positioning a sheet-like belt 422a against and at an angle relative to a sheet-like web 420 such that the belt 422a and web 420 are in contact with one another by a generally flat contact surface. The method proceeds with the step of melting with a single welding process material of the belt 422a and the web 420 across the entire width of the contact surface.

Obviously, many modifications and variations of the present invention are possible in light of the above teachings and may be practiced otherwise than as specifically described while within the scope of this disclosure.

1. A method of welding a sheet-like first work piece to a sheet-like second work piece, comprising the steps of:
positioning the first work piece against and at an angle relative to the second work piece such that the first and second work pieces are in contact with another by a generally flat contact surface; and
melting with a single welding process material of the first and second work pieces across the entire width of the contact surface.

2. The method as set forth in claim 1 wherein said melting step is further defined as melting material of the first and second work pieces across the entire width of the contact surface with a single welding process using a welding assembly aimed the side of the second work piece opposite from the first work piece.

3. The method as set forth in claim 2 wherein the single welding process is at least one of a laser beam welding process and a hybrid laser arc welding process and a friction stir welding process.

4. The method as set forth in claim 1 wherein said melting step is further defined as melting material from the first and second work pieces across the entire width of the contact surface with a single welding process using a welding assembly aimed at a corner at the intersection of the first and second work pieces.

5. The method as set forth in claim 1 wherein the single welding process is one of a laser beam welding process and a hybrid laser arc welding process.

6. A method of making a control arm for a vehicle suspension, comprising the steps of:
positioning a sheet-like belt against and at an angle relative to a sheet-like web such that the belt and web are in contact with one another by a generally flat contact surface; and
melting with a single welding process material of the belt and the web across the entire width of the contact surface.

7. The method as set forth in claim 6, wherein the generally flat contact surface between the belt and web extends through at least one curve.

8. The method as set forth in claim 6 wherein said melting step is further defined as melting material of the belt and web across the entire width of the contact surface with a single welding process using a welding assembly aimed at the side of the belt opposite of the web.

9. The method as set forth in claim 8 wherein the single welding process is at least one of a laser beam welding process and a hybrid laser arc welding process and a friction stir welding process.

10. The method as set forth in claim 6 wherein said melting step is further defined as melting material from the belt and web across the entire width of the contact surface with a single welding process using a welding assembly aimed at a corner at the intersection of the belt and web.

11. The method as set forth in claim 10 wherein the single welding process is one of a laser beam welding process and a hybrid laser arc welding process.
